(19) United States
(12) Patent Application Publication
(10) Pub. No.: US 2026/0160630 A1
(43) Pub. Date: Jun. 11, 2026

(54) PORTABLE DYNAMIC BALANCING DEVICE FOR MARINE AND FACTORY ENGINES

(71) Applicant: IOANNIS PARASKEVOPOULOS, MOSCHATO (GR)

(72) Inventor: IOANNIS PARASKEVOPOULOS, MOSCHATO (GR)

(21) Appl. No.: 18/868,385

(22) PCT Filed: May 26, 2023
(86) PCT No.: PCT/GR2023/000023

§ 371 Date: Nov. 22, 2024

(30) Foreign Application Priority Data
May 27, 2022 (GR) 20220100445

(51) Int. Cl. G01M 1/00

(52) U.S. Cl. CPC G01M 1/00

(57) ABSTRACT

The invention relates to a portable dynamic balancing device for marine and factory engines, which is placed at the point of installation of the engine, for on-site balancing of the shaft (8) of an engine. The device has legs (1) on which beams (3) and bases (4) are fixed. Free-rolling bearings (6) with rollers (7) on which the shaft (8) rests are placed on the bases. Its rotation is done by a belt (17) which receives motion from a motor (16) at the bottom of the device. The motor (16) can be electric, hydraulic or air motor.

### FIELD OF ART

The invention relates to the technical field of mechanical devices and more specifically to the field of mechanical elements and units. It generally relates to the field of elements for producing and maintaining the efficient operation of machinery or facilities. In particular it relates to the field of vibration suppression in systems and even more specifically it relates to a portable dynamic balancing device in marine and factory engines.

### BACKGROUND OF THE INVENTION

The portable dynamic balancing device disclosed in the present invention for marine and factory engines has not been disclosed in the prior art.

Until now, balancing of marine and factory engine rotors is done in specialized machine shops, after the engine has been disassembled and the rotor removed. This means that specialized personnel must undertake to disassemble the machine, remove the rotor, pack it and send it to the place where balancing will take place. After this, the exact opposite process should be done, sending the rotor from the place where it was balanced, back to where the machine is situated. As can be understood, this specific process is particularly time-consuming, requires specialized personnel as well as the disassembly and reassembly of the machine, which often poses risks for its operation, while at the same time it is extremely unprofitable financially. In addition, the machine may often be situated in a location that is not easily accessible, further increasing the difficulty of disassembly and transportation, as well as the corresponding costs. Finally, the risks for the personnel in charge of disassembling, transporting and reassembling the machines should not be overlooked, as it is clear that we are referring to particularly bulky and complex units. Another disadvantage that arises when disassembling and transporting a rotor to a special installation for balancing is the fact that balancing is not done in the actual operating conditions of the machine, but in an ideal environment, outside of its operating place. This means, for example, that for an engine that is balanced outside the marine, the vibrations that may come from external factors, such as the generators operating on the marine, are not taken into account.

To date, in addition to balancing in special facilities, the alternative that has been proposed and implemented concerns the use of portable sensors, which are connected locally to the machines and allow the reading of the critical elements, so that the specialist can carry out a relevant diagnosis of their condition. But what is not possible is the repair of the machines, since the sensors simply record the values.

It is thus an object of the present invention to advantageously address the aforementioned disadvantages and shortcomings of the prior art by proposing a portable dynamic balancing device for marine and factory engines.

A further object of the present invention is to provide a portable dynamic balancing device for marine and factory engines, which does not require disassembling the engine and transporting its shaft to special facilities to perform the balancing.

It is a further object of the present invention to provide a portable dynamic balancing apparatus for marine and factory engines, which is assembled at the place of installation of the engine and operated locally.

A further object of the invention is the presentation of a portable dynamic balancing device for marine and factory engines, which is configurable and applies to different rotor sizes.

Another object of the invention is to provide a portable dynamic balancing device for marine and factory engines, which, due to the fact that it works at the point of installation, takes into account all the conditions that occur during balancing. This means that the balancing is done under real conditions and not in an ideal environment, making it more efficient.

An object of the present invention is also to provide a portable dynamic balancing device for marine and factory engines, which has a low weight, which contributes to the ease of transportation.

An object of the present invention is also to provide a portable dynamic balancing device for marine and factory engines, which has an air suspension system.

These and other objects, features and advantages of the invention will become apparent in the following detailed description.

### BRIEF DESCRIPTION OF THE DRAWINGS

The invention will become apparent to those skilled in the art by reference to the accompanying drawings in which it is illustrated in an illustrative non-limiting manner.

FIG. 1 shows in an isometric drawing an indicative illustration of the portable dynamic balancing device for marine and factory engines, in accordance with the present invention.

FIG. 2 shows in an indicative illustration the face of the portable dynamic balancing device in marine and factory engines of the invention.

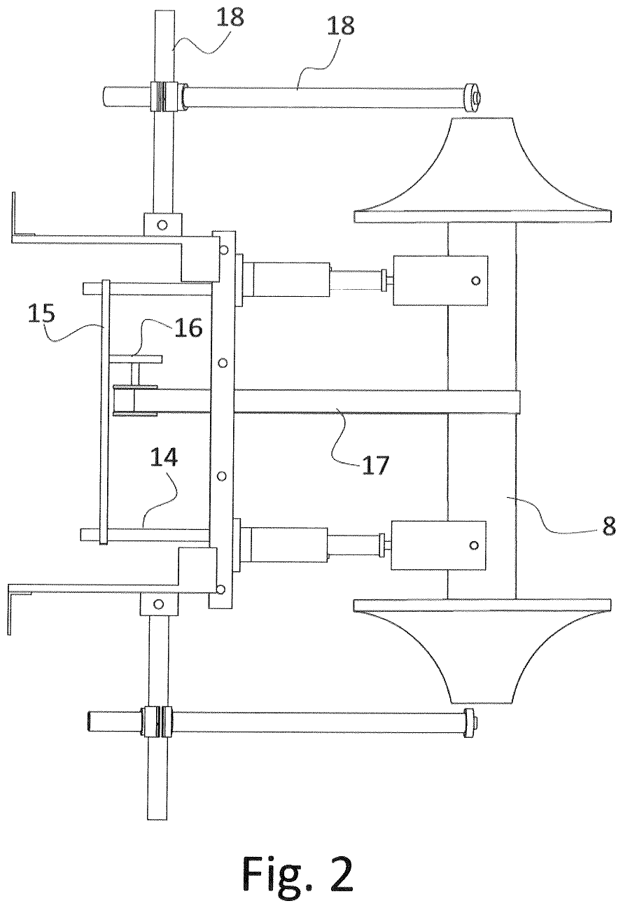

FIG. 3 shows a side view and a section of the device of the invention, the free rolling bearing with its air suspension.

### DETAILED DESCRIPTION OF A PREFERRED EMBODIMENT

Referring now to the accompanying drawings, we will describe illustrative embodiments of a portable dynamic balancing device for marine and factory engines.

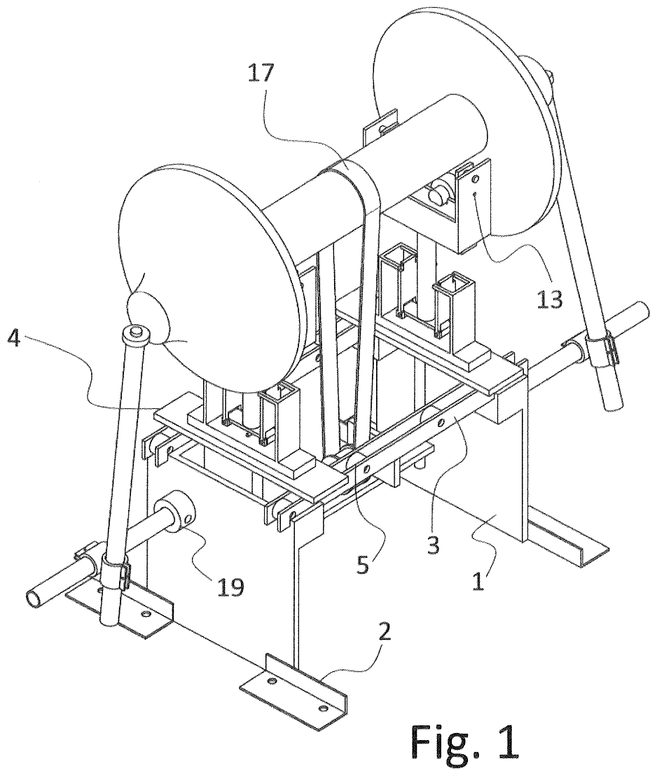

The invention relates to a portable device intended for dynamic balancing of a rotor shaft of marine and factory engines. The device consists of two legs (1), FIG. 1, which are fixed with shoes (2) on the ground of the respective installation, close to the rotor of the machine to be balanced. The distance between the legs (1) is configured according to the length of the rotor shaft to be balanced. Between the two legs (1) are placed beams (3), usually two in number, which are fixed to the legs (1) and which are used to place the bases (4). The beams (3) have intermediate spacers (5) for further damping of impeding vibrations. The beams (3) are adjustable in length, so that the device can be used for balancing rotors of different dimensions.

Two free-rolling bearings (6) are placed on the bases, one on each side. The free-rolling bearings (6) are composite devices that move freely to at least one direction, usually horizontally or vertically to the rotor axis. The theory behind this type of balancing is that the rotor essentially behaves as if it were floating in the air, while the movements of the rotor are measured by vibration sensors to determine its required balance. The free rolling bearings (6) consist of two rollers (7) on which the rotor shaft (8) is placed and which allow its rotation. The rollers (7) are located on a support (9) with a shaft (10). The shaft (10) rests on a base (11) of an easel (12), which oscillates and contributes to the balancing of the rotor. The easels (12) are actually placed on the bases (4). The supports (9) have a socket (13) for their electrical connection with accelerometers, which record the movement of the free-rolling bearings (6) and based on the resulting frequencies, the rotor balancing adjustments are made.

Two strings (14) are attached to the bases (4), which are used to support the rail (15). A motor (16) is placed on the rail (15) and is connected with a belt (17) to the rotor shaft (8), rotating it. The fixed holding of the rotor shaft (8) is achieved by beams (18) that fit into sockets (19) of the legs (1), in order to ensure the safety of people as well as the components during the rotation of the rotor shaft (8). The motor (16) may be of any type, either for example electric, hydraulic or even an air motor, depending on the choice made. If an electric motor is chosen, there should also be a DC to AC inverter. Accordingly, the choice of a hydraulic motor allows simpler connections, without cables and with greater precision in settings.

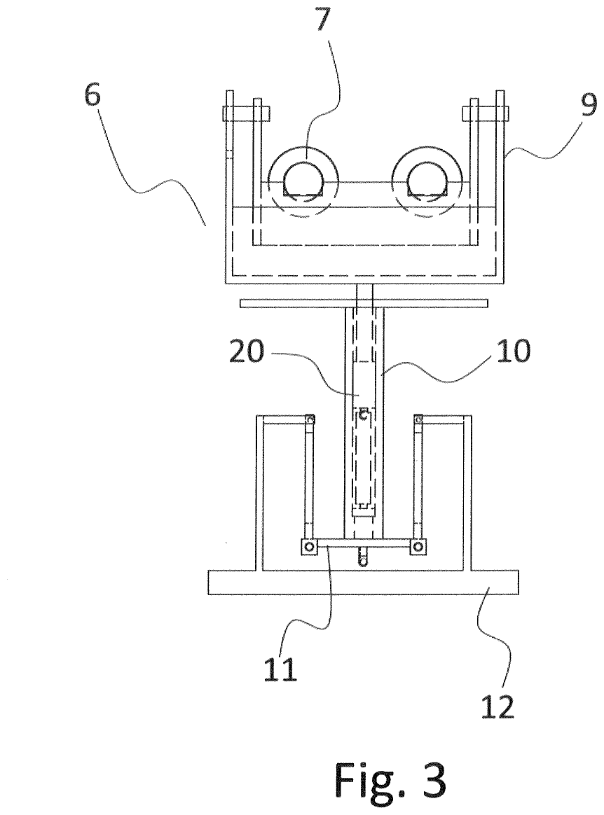

The inside of the shaft (10) of the free-rolling bearings (6) is hollow, FIG. 3, to accommodate air suspension (20), which oscillates up and down, damping the oscillations that occur when balancing the rotor.

It should be noted at this point that the description of the invention was made with reference to indicative embodiments, to which it is not limited. Therefore, any change or modification in terms of shape, dimensions, morphology, materials used and construction and assembly components, as long as they do not constitute a new inventive step and do not contribute to the technical development of what is already known, are considered included in the aims and objectives of the present invention.

1. A portable dynamic balancing device for marine and factory engines, consisting of two legs (1), fixed by shoes (2) to the ground, beams (3) fixed on the legs (1) and bases (4) on the beams (3), where free-rolling bearings (6) are placed on the bases (4), to support the rotor shaft (8) on rollers (7) of the free-rolling bearings (6), which through a belt (17) is connected and receives motion from a motor (16), which is mounted on a rail (15) suspended on strings (14) below the bases (4), characterized in that each free-rolling bearing (6) has a support (9) for the rollers (7) with a hollow shaft (10), which rests on a base (11) of an easel (12) on the base (4), which oscillates and contributes to the balancing of the rotor.

2. The portable dynamic balancing device for marine and factory engines, according to claim 1, characterized in that the beams (3) are of variable length.

3. The portable dynamic balancing device in marine and factory engines, according to claim 1, characterized in that the motor (16) is a hydraulic motor.

4. The portable dynamic balancing device in marine and factory engines, according to claim 1, characterized in that the motor (16) is an air motor.

5. The portable dynamic balancing device in marine and factory engines, according to claim 1, characterized in that within the shaft (10) there is an air suspension (20).
